(19) United States
(12) Patent Application Publication
(10) Pub. No.: US 2021/0342016 A1
(43) Pub. Date: Nov. 4, 2021

(54) WHEEL ASSEMBLY AND ASSOCIATED INPUT DEVICE

(71) Applicant: MICROSOFT TECHNOLOGY LICENSING, LLC, Redmond, WA (US)

(72) Inventors: Wensheng YAO, Beijing (CN); Chunlai ZHANG, Beijing (CN); Ke ZHAO, Beijing (CN)

(21) Appl. No.: 16/462,869

(22) PCT Filed: Nov. 30, 2016
(86) PCT No.: PCT/CN2016/108036

§ 371 Date: May 21, 2019

(51) Int. Cl. G06F 3/0362; G01D 5/14

(52) U.S. Cl. CPC G06F 3/0362; G01D 5/145

(57) ABSTRACT

Embodiments of present disclosure relates to a wheel assembly that can be used with mouse or other input device. The wheel assembly includes a wheel, a magnet for generating a magnetic field, and at least three magnetic sensors for sensing an absolute angular position of the wheel. The magnet coupled to the wheel and operable to rotate with a rotation of the wheel. The at least three magnetic sensors are arranged within a plane that is located in a predetermined distance from the magnet and substantially parallel to a main direction of the magnetic field generated by the magnet. Compared to the conventional sensors that measure the relative position of the wheel, such multiple magnetic sensors based wheel assembly enables a direct absolute angular position measurement.

### FIELD

Embodiments of present disclosure generally relates to an electrical device, and more particularly, to a wheel assembly for use in an input device.

### BACKGROUND

Among various input devices, mouse is widely used for facilitating, for example, the location of a cursor at a target position or scrolling the content of a document displayed on a webpage. In additional to several buttons (such as, the left click button and right click button), most mice are also provided with a wheel (also called a roller or a thumbwheel). A wheel can be scrolled by a user's finger, and rotation of the wheel is subsequently measured and converted to various input signals to realize scrolling, zooming and other operations to the content on the display.

Wheel resolution plays a very important role in a mouse wheel design. However, some of conventional wheels, such as mechanical wheels, cannot achieve a very high resolution due to its internal structure limitation. Infrared wheel, on the other hand, may achieve a high resolution, but it usually relies on a high power consumption, complicated algorithm, and accurate optical structures, such as optical gratings. Furthermore, most of these conventional mice are sensing wheel displacement, which will inherently introduce accumulated errors and drifts.

### SUMMARY

Embodiments of the subject matter described herein provide a wheel assembly that can be used with mouse or other input device. The wheel assembly includes a wheel, a magnet for generating a magnetic field, and at least three magnetic sensors for sensing an absolute angular position of the wheel. The magnet coupled to the wheel and operable to rotate with a rotation of the wheel. The at least three magnetic sensors are arranged within a plane that is located in a predetermined distance from the magnet and substantially parallel to a main direction of the magnetic field generated by the magnet. Compared to the conventional sensors that measure the relative position of the wheel, such multiple magnetic sensors based wheel assembly enables a direct absolute angular position measurement. Further, compared to the currently available infrared sensors or mechanical sensors, such wheel assembly requires less power consumption and has a relative simple design. With such wheel assembly, embodiments of the subject matter described herein achieve an input device with high operation resolution and sensitivity, and meanwhile, it provides high energy efficiency and low manufacture cost.

It is to be understood that the Summary is not intended to identify key or essential features of implementations of the subject matter described herein, nor is it intended to be used to limit the scope of the subject matter described herein. Other features of the subject matter described herein will become easily comprehensible through the description below.

### DESCRIPTION OF DRAWINGS

The above and other objectives, features and advantages of the subject matter described herein will become more apparent through more detailed depiction of example embodiments of the subject matter described herein in conjunction with the accompanying drawings, wherein in the example embodiments of the subject matter described herein, same reference numerals usually represent same components.

FIG. 1 illustrates a perspective view of a wheel assembly for use in an input device, according to embodiments of the present disclosure.

FIG. 2 illustrates a side view of the wheel assembly of FIG. 1.

FIG. 3A illustrates a cross sectional view of a multi-pole magnet.

FIG. 3B illustrates a cross sectional view of another multi-pole magnet.

FIG. 4 illustrates a schematic block diagram of an input device according to the present disclosure.

FIG. 5 illustrates a flowchart of a method for manufacturing a wheel assembly according to embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As used herein, the phrase “include(s)” and its variants shall be interpreted as an open term meaning “including but not limited to.” The phrase “based on” shall be interpreted as “at least partially based on.” The phrase “an embodiment” or “one embodiment” shall be interpreted as “at least one embodiment.” The phrase “another embodiment” shall be interpreted as “at least one other embodiment.” The phrases like “first” and “second” may refer to different or the same objects. Other definitions might also be included explicitly and implicitly in the following description.

Some values or value ranges might be described in the following. It is to be understood that these values and value ranges are only for the purpose of illustration, which may be advantageous to practice the idea of the subject matter described herein. However, depiction of these examples is not intended to limit the scope of the subject matter described herein in any manner. According to the specific application scenarios and needs, the values or value ranges may be set otherwise.

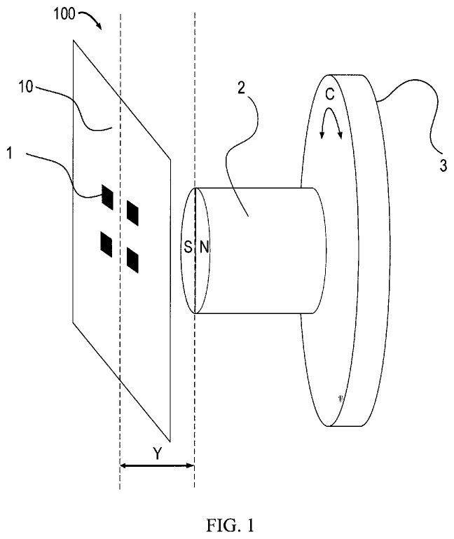

In order to at least partially solve these and some other potential problems, a wheel assembly based on magnetic sensors is proposed in the present disclosure. FIG. 1 illustrates a perspective view of a wheel assembly 100 for use in an input device 200 according to embodiments of the present disclosure. Examples of the input device 200 include, but are not limited to, a mouse, a track ball, or any other forms of pointing devices that can be used in the remote control system. As shown in FIG. 1, the wheel assembly 100 includes a wheel 3, a magnet 2 for generating a magnetic field, and N magnetic sensors 1 where N≥3. That is, there are at least three magnetic sensors 1. In this example as shown in FIG. 1, four sensors (N=4) are shown.

In response to a scroll operation by a user's finger on the wheel 3, the wheel rotates in a tangential direction (C). The magnet 2 is coupled to the wheel 3 and operable to rotate following the wheel 3 rotates. The four magnetic sensors 1 are used together for sensing or determining an absolute angular position of the magnet 2 and thereby the absolute angular position of the wheel 3. It is to be understood that while four sensors are illustrated in FIG. 1, more than four magnetic sensors, such as five, six and more magnetic sensors (N=5, 6, 7, . . . ), or exactly three magnetic sensors (that is, N=3) can also be used. More sensors may help improve the precision in determining the absolute angular position. Also, more sensors may help improve the robustness of the wheel assembly. A trade-off between the high resolution and the low cost may be determined depending on specific requirements.

As mentioned above, traditional wheels usually sense wheel displacement, which will inevitably introduce accumulated errors and drifts. By contrast, wheel assembly according to various embodiments of present disclosure works on the basis of multiple magnetic sensors to sense or determine the absolute angular position of the wheel, thereby enabling a very high resolution in determining the angular position of the wheel. Further, a traditional infrared mouse wheel usually requires high power consumption and accurate optical structures, and a mechanical mouse wheel may not achieve high resolution. Therefore, it is difficult to achieve both power efficiency and high resolution in a conventional mouse. On the contrary, the wheel assembly according to embodiments of present disclosure enables an input device with high operation resolution and sensitivity and meanwhile providing high energy efficiency and low manufacture cost.

In some embodiments, the magnet 2 is a permanent magnet. A permanent magnet does not require external power supply to generate magnetic field as it is made from a material that is magnetized and creates its own persistent magnetic field. As depicted in FIG. 1, in some embodiments, the magnet 2 may have a cylindrical shape and include a semi-cylindrical north pole N and a semi-cylindrical south pole S. It is to be understood that depending on particular requirements, the magnets 2 having other shapes or types/configurations, such as ring-shape magnet or disc-shape magnet are also possible.

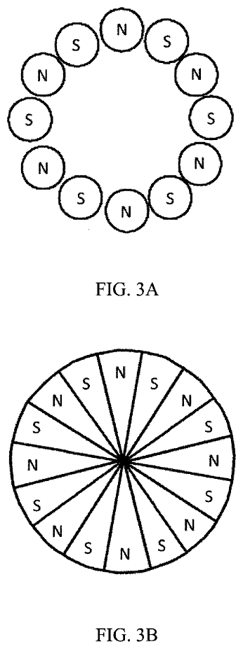

In some embodiments, as depicted in FIGS. 3A and 3B, a magnet including a plurality of North poles and a plurality of South poles (also called multi-pole magnet) may be utilized to achieve a high detection resolution. For this type of multi-pole magnet, the number of N/S pole pairs has a direct impact on the detection resolution. In other words, the more N/S pole pairs the magnet has, the higher resolution can be achieved. Accordingly, the number of N/S pole pairs and the number of magnetic sensors should be coprime.

As further illustrated in FIG. 1, the four magnetic sensors 1 are arranged within a plane 10 that is located in a predetermined distance Y from the magnet 2 and substantially parallel to a main direction B of the magnetic field generated by the magnet 2. As shown in FIG. 1, the main direction B of the generated magnetic field is pointing from the North Pole N to the South Pole S, and the main direction B of the magnetic field will also rotate along with the rotation of the magnet 2. It is to be understood that the predetermined distance Y as shown in FIG. 1 may be tuned within a range, so that those magnetic sensors located within that distance range may effectively detect the magnetic field generated by the magnet 2. In some embodiments, the predetermined distance Y between the magnet 2 and plane 10 may be quite small, so as to achieve a reliable sensing and small space occupation.

Still in reference to FIG. 1, in response to a scroll operation by a user's finger on the wheel 3, the magnet 2 will rotate along with the wheel 3 as well. The main direction B of the magnetic field generated by the magnet 2 over the at least three magnetic sensors 1 will rotate or spin accordingly. Depending on the angle difference between any two adjacent (in location) magnetic sensors 1, output electrical signal from any two adjacent magnetic sensors will have a corresponding phase difference. In other words, the angle difference between the physical locations of two magnetic sensors can be converted into the phase difference between the output signals (for example, electrical signals) from the magnetic sensors.

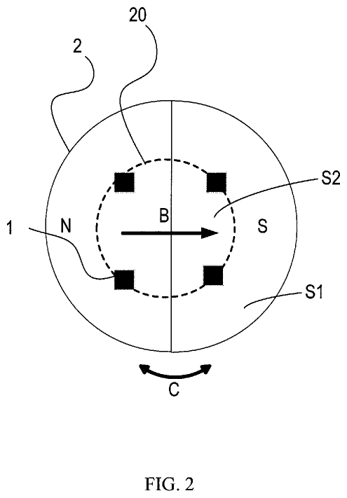

In some embodiments, as illustrated in FIG. 2, the at least three magnetic sensors 1 are substantially equally spaced along a tangential direction C of the rotation of the wheel 3. In those embodiments, during the rotation of the magnet, the detected magnetic field by any two adjacent magnetic sensors has a same phase difference of 360 degrees divided by N. As illustrated in FIG. 2, in some embodiments, the at least three magnetic sensors 1 are equally arranged on a circle 20. Such design symmetry helps maintain the measured magnetic field by each sensor to be within a same range. In other words, there is a phase difference between magnetic fields detected by two adjacent magnetic sensors, and the maximum and minimum intensities of the magnetic field detected by each magnetic sensor is substantially the same.

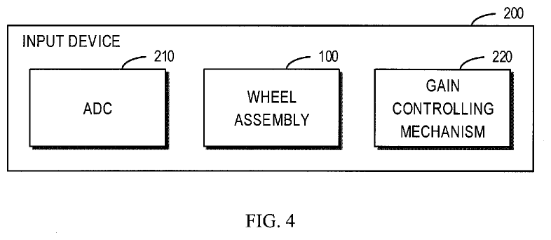

As an example, in the case of N=3, the detected magnetic field by any two adjacent magnetic sensors will have a phase difference of 120 degrees, which corresponds to the angle difference of 120 degrees between any two adjacent sensors on the plane 10 (or on the circle 20). Subsequently, along with the spin of the magnet 2, with respect to various absolute angular positions (from 0-360 degrees), the detected magnetic field from each sensor will be converted into a measurable (for example, electrical) sinusoidal or substantially sinusoidal waveform. Such conversion from the magnetic field to a measurable signal may further relies on the digital algorithm stored on an analog-to-digital (ADC) convertor 210, which will be shown in details in FIG. 4. Then the wheel's current absolute angular position can be determined through a group of amplitudes measured from all the three sensors.

In particular, within a full spinning circle of the magnet 2 (that is, within a rotation from 0 to 360 degrees), the converted sinusoidal electrical signal representative of the amplitude of magnetic field detected by each individual magnetic sensor will follow the sinusoidal wave, with the three sinusoidal curves having a phase difference of 120 degrees in between. In this case, at a given moment within the entire spin cycle, the wheel's absolute angular position can be uniquely interpreted to be a particular group of amplitude values containing three amplitude values measured from the respective sensor, and no two groups of amplitude values within the spin cycle are identical. In this way, the current angular position can be uniquely identified.

In some embodiments, the at least three magnetic sensors 1 may be Hall sensors. Hall sensors can be used in proximity switching, positioning, speed detection, and current sensing applications. Hall sensors are cost-effective and can measure a wide range of magnetic fields. Further, Hall sensors may be fabricated as flat components as illustrated in FIGS. 1 and 2, which save the space occupation and may improve its integrity with other components.

Continuing to refer to FIG. 2, in some embodiments, an area S1 of a cross section of the magnet 2 is larger than an area S2 of the circle 20. The larger area S1 of the cross section of the magnet 2 enables majority of the magnetic field generated by the magnet 2 with strong and uniform field strength can interact with those sensors distributed on the circle 20, which improves the detection sensitivity.

In some embodiments, as shown in FIG. 2, the circle 20 is coaxially aligned with the magnet 2. By coaxially aligning the magnet 2 with the center of the circle 20, a further design symmetry can be introduced, which further improves the detection sensitivity.

In some embodiments, the circle 20 may have a diameter in a range of 1 mm-3 mm, and the cross section of the magnet 2 has a diameter in a range of 4 mm to 6 mm, for example. In an example design, the circle 20 may have a diameter of 2 mm, and accordingly the cross section of the magnet 2 may to have a diameter of 4 mm.

FIG. 4 illustrates a schematic block diagram of an input device 200. As shown, in general, the input device 200 includes the wheel assembly 100 according to embodiments of the subject matter described herein, an analog-to-digital convertor (ADC) 210, and a gain control mechanism 220. The wheel assembly 100 can be the wheel assembly as depicted in FIGS. 1 and 2. The ADC 210 is used for converting a magnetic field detected by the at least three magnetic sensors 1 into a measurable electrical signal. For instance, with a 10-bit ADC 210, a resolution of 1024 counts/turn can be achieved. The gain control mechanism 220 is used for adjusting, especially automatic adjusting an intensity of the electrical signal.

In some embodiments, the at least three magnetic sensors 1, the ADC 210 and the gain control mechanism 220 can be integrated on a same circuit board or on a same chip. In this way, the integrity of the input device 200 will be further enhanced, and meanwhile a simple fabrication/assembly of such input device 200 can also be achieved.

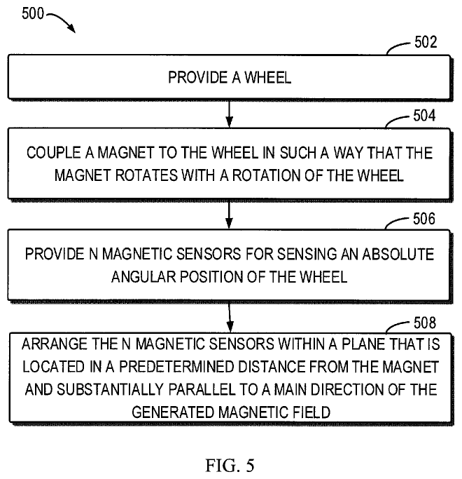

FIG. 5 illustrates a flowchart of a method 500 for manufacturing a wheel assembly 100 according to embodiments of the present disclosure. It should be understood that the method 500 may also include additional actions not shown and/or omit the illustrated steps. Scope of the subject matter described herein is not limited in this aspect.

At 502, it is provided a wheel 3. At 504, a magnet 2 for generating magnetic field is coupled to the wheel 3 in such a way that the magnet 2 rotates with a rotation of the wheel 3. At 506, it is provided at least three magnetic sensors 1 for sensing an absolute angular position of the wheel 3. At 508, the at least three magnetic sensors 1 is arranged within a plane 10 that is located in a predetermined distance Y from the magnet 2 and substantially parallel to a main direction B of the magnetic field generated by the magnet 2. It is to be understood that the features as described above all apply to the method 500, which will not be repeated here.

Hereinafter, some example implementations of the subject matter described herein will be enumerate.

In some embodiments, a wheel assembly for use in an input device is provided. The wheel assembly comprises: a wheel; a magnet coupled to the wheel for generating a magnetic field and operable to rotate with a rotation of the wheel; and at least three magnetic sensors for sensing an absolute angular position of the wheel, the at least three magnetic sensors being arranged within a plane that is located in a predetermined distance from the magnet and substantially parallel to a main direction of the magnetic field generated by the magnet.

In some embodiments, the magnet is a permanent magnet.

In some embodiments, the magnet has a cylindrical shape and includes a semi-cylindrical north pole and a semi-cylindrical south pole.

In some embodiments, the magnet includes a plurality of North poles and a plurality of South poles.

In some embodiments, the at least three magnetic sensors are substantially equally spaced along a tangential direction of the rotation of the wheel.

In some embodiments, the at least three magnetic sensors are arranged on a circle.

In some embodiments, the at least three magnetic sensors are Hall sensors.

In some embodiments, an area of a cross section of the magnet is larger than an area of the circle.

In some embodiments, the circle is coaxially aligned with the magnet.

In some embodiments, the circle has a diameter in a range of 1 mm-3 mm, and the cross section of the magnet has a diameter in a range of 4 mm-6 mm.

In some embodiments, an input device is provided. The input device comprises: a wheel; a magnet coupled to the wheel for generating a magnetic field and operable to rotate with a rotation of the wheel; at least three magnetic sensors for sensing an absolute angular position of the wheel, the at least three magnetic sensors being arranged within a plane that is located in a predetermined distance from the magnet and substantially parallel to a main direction of the magnetic field generated by the magnet; a ADC for converting a magnetic field detected by the at least three magnetic sensors into a measurable electrical signal; and a gain control mechanism for adjusting an intensity of the electrical signal.

In some embodiments, the magnet is a permanent magnet.

In some embodiments, the magnet has a cylindrical shape and includes a semi-cylindrical North pole and a semi-cylindrical South pole.

In some embodiments, the magnet includes a plurality of North poles and a plurality of South poles.

In some embodiments, the at least three magnetic sensors are substantially equally spaced along a tangential direction of the rotation of the wheel.

In some embodiments, the at least three magnetic sensors are arranged on a circle.

In some embodiments, the at least three magnetic sensors are Hall sensors.

In some embodiments, an area of a cross section of the magnet is larger than an area of the circle.

In some embodiments, the circle is coaxially aligned with the magnet.

In some embodiments, the circle has a diameter in a range of 1 mm-3 mm, and the cross section of the magnet has a diameter in a range of 4 mm to 6 mm.

In some embodiments, the at least three magnetic sensors, the ADC and the gain control mechanism are integrated on a same circuit board.

In some embodiments, a method of manufacturing a wheel assembly is provided. The method comprises: providing a wheel; coupling a magnet for generating magnetic field to the wheel in such a way that the magnet rotates with a rotation of the wheel; providing at least three magnetic sensors for sensing an absolute angular position of the wheel; and arranging the at least three magnetic sensors within a plane that is located in a predetermined distance from the magnet and substantially parallel to a main direction of the magnetic field generated by the magnet.

In some embodiments, the magnet is a permanent magnet.

In some embodiments, the magnet has a cylindrical shape and includes a semi-cylindrical north pole and a semi-cylindrical south pole.

In some embodiments, the magnet includes a plurality of North poles and a plurality of South poles.

In some embodiments, arranging the at least three magnetic sensors includes substantially equally spacing the at least three magnetic sensors along a tangential direction of the rotation of the wheel.

In some embodiments, the at least three magnetic sensors are arranged on a circle.

In some embodiments, the at least three magnetic sensors are Hall sensors.

In some embodiments, an area of a cross section of the magnet is larger than an area of the circle.

In some embodiments, the circle has a diameter in a range of 1 mm-3 mm, and the cross section of the magnet has a diameter in a range of 4 mm-6 mm.

In some embodiments, arranging the at least three magnetic sensors further comprises coaxially aligning the circle with the magnet.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

What is claimed is:

1. A wheel assembly (100) for use in an input device (200), the wheel assembly (100) comprising:
a wheel (3);
a magnet (2) coupled to the wheel (3) for generating a magnetic field and operable to rotate with a rotation of the wheel (3); and
at least three magnetic sensors (1) for sensing an absolute angular position of the wheel (3),
the at least three magnetic sensors (1) being arranged within a plane (10) that is located in a predetermined distance (Y) from the magnet (2) and substantially parallel to a main direction (B) of the magnetic field generated by the magnet (2).

2. The wheel assembly (100) of claim 1, wherein the magnet (2) is a permanent magnet.

3. The wheel assembly (100) of claim 1, wherein the magnet (2) has a cylindrical shape and includes a semi-cylindrical North pole (N) and a semi-cylindrical South pole (S).

4. The wheel assembly (100) of claim 1, wherein the magnet (2) includes a plurality of North poles (N) and a plurality of South poles (S).

5. The wheel assembly (100) of claim 3, wherein the at least three magnetic sensors (1) are substantially equally spaced along a tangential direction (C) of the rotation of the wheel (3).

6. The wheel assembly (100) of claim 5, wherein the at least three magnetic sensors (1) are arranged on a circle (20).

7. The wheel assembly (100) of claim 1, wherein the at least three magnetic sensors (1) are Hall sensors.

8. The wheel assembly (100) of claim 6, wherein an area (S1) of a cross section of the magnet (2) is larger than an area (S2) of the circle (20).

9. The wheel assembly (100) of claim 8, wherein the circle (20) is coaxially aligned with the magnet (2).

10. The wheel assembly (100) of claim 8, wherein the circle (20) has a diameter in a range of 1 mm-3 mm, and the cross section of the magnet (2) has a diameter in a range of 4 mm to 6 mm.

11. An input device (200), comprising:
a wheel (3);
a magnet (2) coupled to the wheel (3) for generating a magnetic field and operable to rotate with a rotation of the wheel (3);
at least three magnetic sensors (1) for sensing an absolute angular position of the wheel (3), the at least three magnetic sensors (1) being arranged within a plane (10) that is located in a predetermined distance (Y) from the magnet (2) and substantially parallel to a main direction (B) of the magnetic field generated by the magnet (2);
an analog-to-digital convertor (ADC) (210) for converting a magnetic field detected by the at least three magnetic sensors (1) into a measurable electrical signal; and
a gain control mechanism (220) for adjusting an intensity of the electrical signal.

12. The input device (200) of claim 11, wherein the magnet (2) has a cylindrical shape and includes a semi-cylindrical North pole (N) and a semi-cylindrical South pole (S).

13. The wheel assembly (100) of claim 11, wherein the magnet (2) includes a plurality of North poles (N) and a plurality of South poles (S).

14. The input device (200) of claim 12, wherein the at least three magnetic sensors (1) are substantially equally spaced along a tangential direction (C) of the rotation of the wheel (3).

15. The input device (200) of claim 14, wherein the at least three magnetic sensors (1) are arranged on a circle (20).

16. The input device (200) of claim 11, wherein the at least three magnetic sensors (1) are Hall sensors.

17. The input device (200) of claim 15, wherein an area (S1) of a cross section of the magnet (2) is larger than an area (S2) of the circle (20).

18. The input device (200) of claim 16, wherein the circle (20) has a diameter in a range of 1 mm-3 mm, and the cross section of the magnet (2) has a diameter in a range of 4 mm to 6 mm.

19. The input device (200) of claim 11, wherein the at least three magnetic sensors (1), the ADC (210) and the gain control mechanism (220) are integrated on a same circuit board.

20. A method of manufacturing a wheel assembly (100), comprising:
providing a wheel (3);
coupling a magnet (2) for generating magnetic field to the wheel (3) in such a way that the magnet (2) rotates with a rotation of the wheel (3);
providing at least three magnetic sensors (1) for sensing an absolute angular position of the wheel (3); and
arranging the at least three magnetic sensors (1) within a plane (10) that is located in a predetermined distance (Y) from the magnet (2) and substantially parallel to a main direction (B) of the magnetic field generated by the magnet (2).
